(19) United States
(12) Patent Application Publication
(10) Pub. No.: US 2012/0214320 A1
(43) Pub. Date: Aug. 23, 2012

(54) CIRCUIT BOARD AND CONNECTOR THEREOF

(76) Inventors: Chong-Liang YE, Jiangsu (CN); Yin-Peng Li, Jiangsu (CN)

(21) Appl. No.: 13/149,422

(22) Filed: May 31, 2011

(30) Foreign Application Priority Data
Feb. 18, 2011 (TW) 100105448

(51) Int. Cl. H01R 13/66; H01R 12/00

(52) U.S. Cl. 439/55; 439/620.21

(57) ABSTRACT

A high-voltage surge protective connector for connecting with an external cable is disclosed. The connector includes a first connecting end, a second connecting end, a transformer, and a protection module. The second connecting end is connected with the external cable. The transformer includes a primary coil and a secondary coil. The primary coil is electrically connected with the first connecting end, and the secondary coil is electrically connected with the second connecting end. The secondary coil includes a center tap. The protection module is disposed between the center tap and the ground. The protection module includes a first portion and a second portion. The first portion is electrically connected with the ground. A gap exists between the first portion and the second portion. A point discharge happens between the first portion and the second portion when the high-voltage surge is generated.

### CROSS REFERENCE TO RELATED APPLICATIONS

This Non-provisional application claims priority under 35 U.S.C. §119(a) on Patent Application No(s). 100105448 filed in Taiwan, Republic of China on Feb. 18, 2011, the entire contents of which are hereby incorporated by reference.

### BACKGROUND OF THE INVENTION

1. Field of Invention

The invention relates to a connector and, more particularly, to a connector with a surge-proof function.

2. Related Art

A network chip is usually disposed at a conventional motherboard to provide the network connection function. The network chip can be connected with Internet wired or wirelessly.

In the wired connection mode, the network chip is connected with an external cable via a network connector. FIG. 1 is a circuit diagram showing a conventional network connector. The input pins P9 to P18 of a network connector 100 are connected with the network chip (not shown in the figure), and the output pins J1 to J8 are connected with an external cable (not shown in the figure). Signal can be transmitted between the external cable and the network chip via the network connector 100.

However, since the network chip is electrically connected with the external cable, the external cable may transmit the generated high-voltage surge to the network connector and further to the network chip when lightning strike happens. If no surge-proof protection is taken, the high-voltage surge may damage the network chip resulting in the damage of the motherboard.

A conventional surge-proof structure is showed in FIG. 1. The network connector 100 includes a plurality of transformers 101, and each transformer 101 includes a primary coil 101a and a secondary coil 101b. The center tap M of the secondary coil 101b in the transformer 101 is connected with a resistor 102. The resistor 102 is electrically connected with a capacitor 103, and the capacitor 103 is grounded. Usually, the impedance of the resistor is 75 ohm, and the capacitance is 0.1 UF. When the high-voltage surge is generated, current is grounded via the resistor 102 and the capacitor 103, which would not be coupled to the coils and damage the network chip.

However, the conventional surge-proof structure cannot defend against the high-voltage surge when the generated voltage by the lighting is high. The high-voltage surge may enter the network chip directly to damage the network chip. Furthermore, the resistor and the capacitor may be breakdown by the high-voltage surge, which makes the connection of the network connector failed.

### SUMMARY OF THE INVENTION

A high-voltage surge-proof connector for connecting with an external cable is provided. The connector includes a first connecting end, a second connecting end, a transformer, and a protection module. The second connecting end is connected with the external cable. The transformer includes a primary coil and a secondary coil. The primary coil is electrically connected with the first connecting end, and the secondary coil is electrically connected with the second connecting end. The secondary coil includes a center tap. The protection module is disposed between the center tap and the ground. The protection module includes a first portion and a second portion. The first portion is electrically connected with a ground, and a gap exists between the first portion and the second portion. A point discharge happens between the first portion and the second portion when the high-voltage surge is generated.

A circuit with a high-voltage surge protective connector is also provided. The circuit board includes a network chip and a connector. The connector is for connecting with an external cable. The connector includes a first connecting end, a second connecting end, a transformer, and a protection module. The first connecting end is connected with the network chip. The second connecting end is connected with the external cable. The transformer includes a primary coil and a secondary coil. The primary coil is electrically connected with the first connecting end, and the secondary coil is electrically connected with the second connecting end. The secondary coil includes a center tap. The protection module is disposed between the center tap and the ground. The protection module includes a first portion and a second portion. The first portion is electrically connected with a ground. A gap exists between the first portion and the second portion. A point discharge happens between the first portion and the second portion when the high-voltage surge is generated.

The connector and the circuit board in the embodiments does not need the resistor and the capacitor, and thus to avoid the network chip cannot be electrically connected correctly with the network cable when the capacitor is electrically breakdown. In the connector of an embodiment, the first portion and the second portion are not connected with each other and are taken as the protection module. Normally, the data connection between the network chip and the network line is not affected, and when the high-voltage surge happens, the point discharge happened between the first portion and the second portion can protect the network chip against damage. The use of the protection module prevents of electrically breakdown, and it has simple production process, low production cost, and extensive application prospect.

### BRIEF DESCRIPTION OF THE DRAWINGS

FIG. 1 is a circuit diagram showing a conventional connector.

FIG. 2 is a circuit diagram showing a connector in an embodiment.

FIG. 3 is a schematic diagram showing a protection module in a first embodiment.

FIG. 4 is a schematic diagram showing a protection module in a second embodiment.

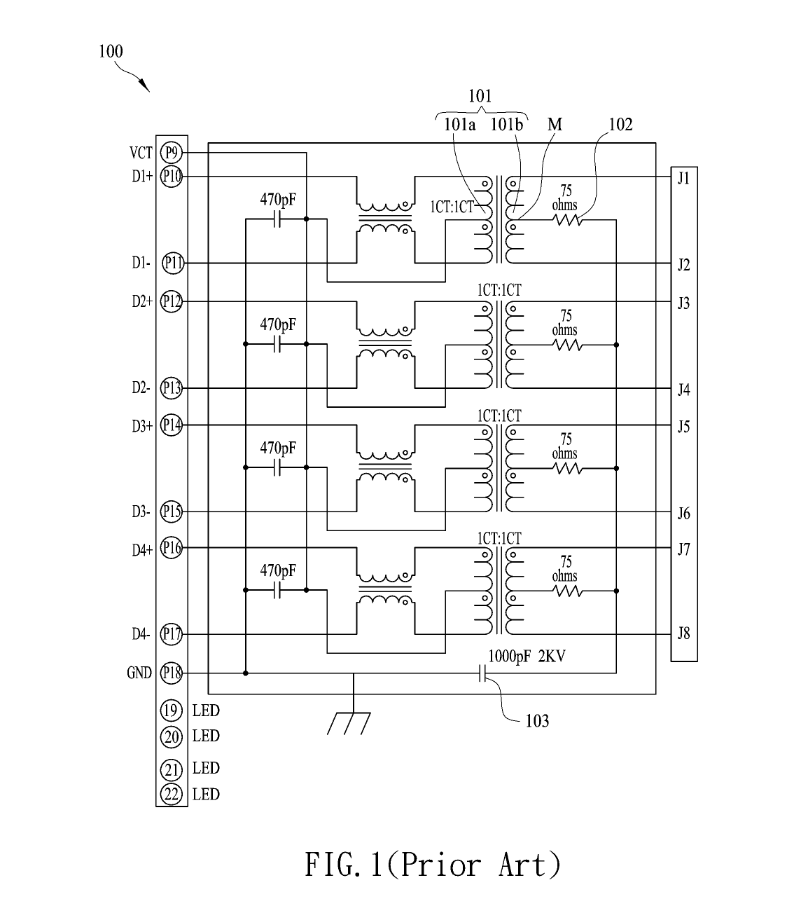

### DETAILED DESCRIPTION OF THE INVENTION

The features of the present invention will become better understood with regard to the following description and accompanying drawings.

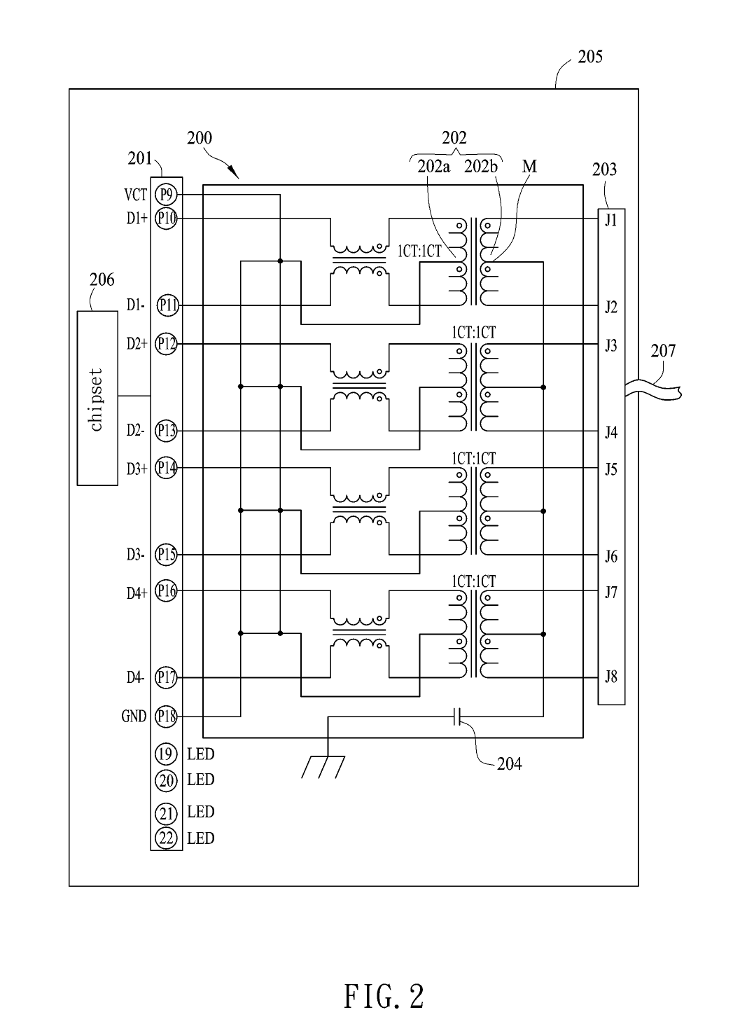

FIG. 2 is a circuit diagram showing a connector in an embodiment. Please refer to FIG. 2. A connector 200 is disposed on a circuit board 205. The connector 200 is a network connector in this embodiment for connecting a network chip and an external network cable, but it is not limited herein.

The connector 200 includes a first connecting end 201, at least one transformer 202, a second connecting end 203, and a protection module 204.

The first connecting end 201 is connected with the network chip 206 or a processing circuit on the circuit board 205. The second connecting end 203 is connected with an external network cable.

The transformer 202 includes a primary coil 202a and a secondary coil 202b. The primary coil 202a is connected with the first connecting end 201, and the secondary coil 202b is connected with the second connecting end 203. The secondary coil 202b includes a center tap M.

The protection module 204 is disposed between the center tap M of the secondary coil 202b and the ground for releasing the voltage and the generated current to the ground when a high-voltage surge generates.

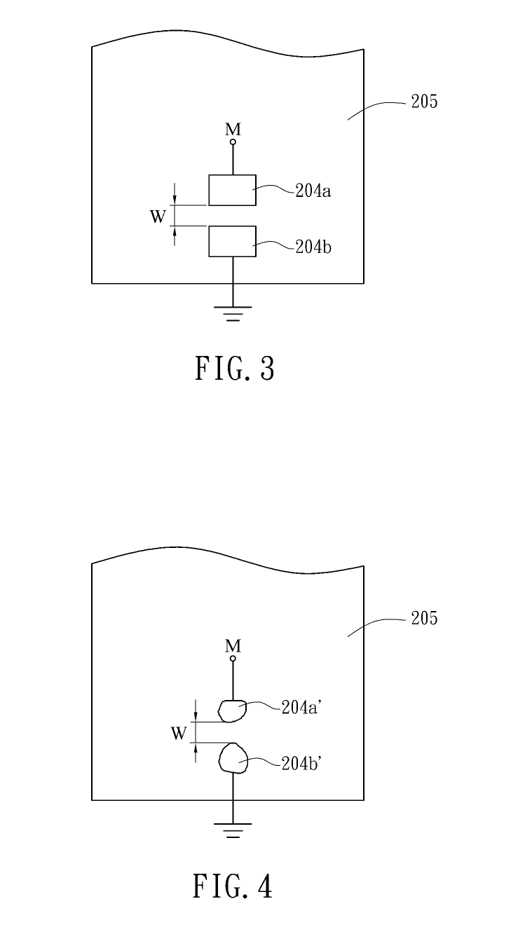

The structure of the protection module 204 can be seen in FIG. 3.

In this embodiment, the other components on the circuit board 205, except for the protection module 204, can be known by people with ordinary skill in the art, which is omitted herein. The protection module 204 includes the first portion 204a and the second portion 204b. The first portion 204a is electrically connected with the center tap M of the secondary coil 202b. The second portion 204b is electrically connected with the ground.

A gap W exists between the first portion 204a and the second portion 204b to make the first portion 204a and the second portion 204b disconnected. Consequently, if the first portion 204a and the second portion 204b operate normally, the signal transmission of the connector 200 would not be affected. Only when a high-voltage surge is transmitted into the connector 200 via a network cable 207, the first portion 204a and the second portion 204b transmit the high-voltage surge to the ground via the point discharge to prevent the connector 200 and the network chip being damaged by the high-voltage.

The distance W of the gap between the first portion 204a and the second portion 204b is not limited. In an embodiment, the distance W of the gap is between 5 mil and 15 mil. In another embodiment, when the distance W of the gap is 10 mil and the voltage of the high-voltage surge is higher than 600V, the point discharge happens between the first portion 204a and the second portion 204b to transmit the high-voltage to the ground. It can be understood that people with ordinary skill in the art may select different distances W of the gap to meet the different demands of products.

In an embodiment, the first portion 204a and the second portion 204b is made of metal, which is the good conductor of electricity. In an embodiment, the metal may be copper. In addition, in another embodiment, to prevent oxidation and corrosion caused by being exposed in the air, the surface of the protection module can be coated with one or more layers of the anti-oxidation and corrosion-resistant coat. For example, the first portion 204a and the second portion 204b are coated with a layer of nickel whose character is stable, and then coated with a layer of gold.

FIG. 4 is a schematic diagram showing the protection module in a second embodiment.

The difference between the first and the second embodiments is the shape of the first portion 204a′ and that of the second portion 204b′.

The shape of the first portion 204a′ and the second portion 204b′ is not limited herein. People with ordinary skill in the art can understand that if the gap W is formed to generate the point discharge when the high-voltage surge is generated, the shape of the first portion 204a′ and the second portion 204b′ can be determined freely and not limited herein. For example, the first portion 204a′ and the second portion 204b′ is irregular shaped as showed in FIG. 4.

In sum, the conventional network connector includes many resistors and capacitors, and when the capacitor is electrically breakdown, the network chip cannot be correctly electrically connected with the network line to transmit data. In contrast, in the embodiments of the invention, the first portion and the second portion are disconnected with each other and are taken as the protection module. Normally, the data connection between the network chip and the network line is not effected, and when the high-voltage surge happens, the point discharge happened between the first portion and the second portion can protect the network chip against damage. The use of the protection module prevents of electrically breakdown, and it has simple production process, low production cost, and extensive application prospect.

Although the present invention has been described in considerable detail with reference to certain preferred embodiments thereof, the disclosure is not for limiting the scope of the invention. Persons having ordinary skill in the art may make various modifications and changes without departing from the scope of the invention. Therefore, the scope of the appended claims should not be limited to the description of the preferred embodiments described above.

What is claimed is:

1. A connector for connecting an external cable, the connector comprising:
a first connecting end;
a second connecting end for connecting with the external cable;
a transformer, comprising a primary coil and a secondary coil, wherein the primary coil is electrically connected with the first connecting end, the secondary coil is electrically connected with the second connecting end, and the secondary coil includes a center tap; and
a protection module disposed between the center tap and a ground, wherein the protection module includes:
a first portion electrically connected with the center tap; and
a second portion electrically connecting with the ground, wherein a gap exists between the first portion and the second portion, and a point discharge happens between the first portion and the second portion when a high-voltage surge is generated.

2. The connector according to claim 1, wherein the protection module is made of copper.

3. The connector according to claim 1, wherein a surface of the protection module is coated with anti-oxidation and corrosion-resistant coat.

4. The connector according to claim 1, wherein the first portion and the second portion is irregular shaped.

5. The connector according to claim 1, wherein the distance of the gap is between 5 mil to 15 mil.

6. A circuit board, comprising:
a chip, and
a connector for connecting the chip and an external cable, wherein the connector includes:
a first connecting end connected with the chip;
a second connecting end connected with the external cable;
a transformer including a primary coil and a secondary coil, wherein the primary coil is electrically connected with the first connecting end, the secondary coil is electrically connected with the second connecting end, and the secondary coil includes a center tap; and
a protection module disposed between the center tap and a ground, wherein the protection module includes:
a first portion electrically connected with the center tap; and
a second portion electrically connecting with the ground, wherein a gap exists between the first portion and the second portion, and a point discharge happens between the first portion and the second portion when a high-voltage surge is generated.

7. The circuit board according to claim 6, wherein the protection module is made of copper.

8. The circuit board according to claim 6, wherein a surface of the protection module is coated with anti-oxidation and corrosion-resistant coat.

9. The circuit board according to claim 6, wherein the first portion and the second portion is irregular shaped.

10. The circuit board according to claim 6, wherein the distance of the gap is between 5 mil and 15 mil.
